(19) United States
(12) Patent Application Publication
(10) Pub. No.: US 2020/0307636 A1
(43) Pub. Date: Oct. 1, 2020

(54) CONTROL DEVICE INSTALLED IN AUTONOMOUS DRIVING VEHICLE AND CONTROL METHOD

(71) Applicant: DENSO CORPORATION, Kariya-city (JP)

(72) Inventor: Yuji OTA, Kariya-city (JP)

(21) Appl. No.: 16/901,665

(22) Filed: Jun. 15, 2020

Related U.S. Application Data
(63) Continuation of application No. PCT/JP2018/041772, filed on Nov. 12, 2018.

(30) Foreign Application Priority Data
Dec. 19, 2017 (JP) 2017-242439

(51) Int. Cl. B60W 60/00; B60W 50/14; B60W 30/18

(52) U.S. Cl. CPC B60W 60/0025; B60W 2050/146; B60W 30/18009; B60W 50/14

(57) ABSTRACT

A control device on an autonomous driving vehicle acquires information representing a type of a drive operation and a reason for an implementation of the drive operation being performed during an autonomous operation of the autonomous driving vehicle; and controls a notification device to notify information representing the implementation of the drive operation accompanying a horizontal movement and information representing a reason to move horizontally before the implementation of the drive operation when an acquired type of the drive operation at least corresponds to the drive operation accompanying horizontal movement.

### CROSS REFERENCE TO RELATED APPLICATION

The present application is a continuation application of International Patent Application No. PCT/JP2018/041772 filed on Nov. 12, 2018, which designated the U.S. and claims the benefit of priority from Japanese Patent Application No. 2017-242439 filed on Dec. 19, 2017. The entire disclosures of all of the above applications are incorporated herein by reference.

### TECHNICAL FIELD

The present disclosure relates to a control device installed in an autonomous driving vehicle and a control method.

### BACKGROUND

There have been proposed technologies to provide various information to vehicle drivers. For example, the interior information provision device provides a driver with information appropriate for the driver's subjective view (such as information about the purchase activity).

### SUMMARY

According to an example embodiment, a control device on an autonomous driving vehicle acquires information representing a type of a drive operation and a reason for an implementation of the drive operation being performed during an autonomous operation of the autonomous driving vehicle; and controls a notification device to notify information representing the implementation of the drive operation accompanying a horizontal movement and information representing a reason to move horizontally before the implementation of the drive operation when an acquired type of the drive operation at least corresponds to the drive operation accompanying horizontal movement.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram illustrating a schematic configuration of the automated driving vehicle;

FIG. 2 is a diagram illustrating the relationship between an acceleration and an information notification magnitude;

FIG. 3 is a graph illustrating the relationship between an acceleration and an information notification magnitude;

FIG. 4 is a diagram illustrating a notification method corresponding to the information notification magnitude;

FIG. 5 is a flowchart illustrating a horizontal notification process;

FIG. 6 is a flowchart illustrating a speed change notification process;

FIG. 7 is a diagram illustrating a state in which an automated driving vehicle travels within one lane;

FIG. 8 is a diagram illustrating a state in which an automated driving vehicle travels an intersection;

FIG. 9 is a diagram illustrating a state in which an automated driving vehicle changes a lane;

FIG. 10 is a diagram illustrating a state in which an automated driving vehicle travels a tight curve;

FIG. 11 is a diagram illustrating a state in which an automated driving vehicle merges to a main lane from a merging lane;

FIG. 12 is a diagram illustrating a state in which an automated driving vehicle performs emergency avoidance;

FIG. 13 is a flowchart illustrating notification processes;

FIG. 14 is a flowchart illustrating a lane change notification process;

FIG. 15 is a flowchart illustrating an intersection-turns notification process;

and

FIG. 16 is a flowchart illustrating an intersection straight-travel notification process.

### DETAILED DESCRIPTION

Recently, a highly technologically advanced automated driving vehicle is operated based on automatically determined drive operations. However, it is difficult for an occupant to foresee drive operations caused by the vehicle. When the vehicle performs an unintended drive operation, the occupant needs to interrupt the drive operation based on quick decisions. A conceivable technology can provide a driver with information appropriate for the driver's subjective view but has no concern for the provision of information about the automatic operation. There is a need for a technology that enables an occupant to easily foresee drive operations caused by the automated driving vehicle.

A control device mounted on an autonomous driving vehicle and a control method are provided.

According to an example embodiment, a control device mounted on an autonomous driving vehicle, includes: an acquisition portion that acquires information representing a type of a drive operation and a reason for the drive operation being to be performed during an autonomous driving operation of the autonomous driving vehicle; and a notification portion that controls a notification device to notify information representing the drive operation for moving in a horizontal direction being to be performed and information representing the reason to move in the horizontal direction before the drive operation is performed when an acquired type of the drive operation corresponds to at least the drive operation for moving in the horizontal direction.

The control device according to this aspect enables an occupant to easily foresee drive operations automatically performed in the autonomous driving vehicle.

### A. First Embodiment

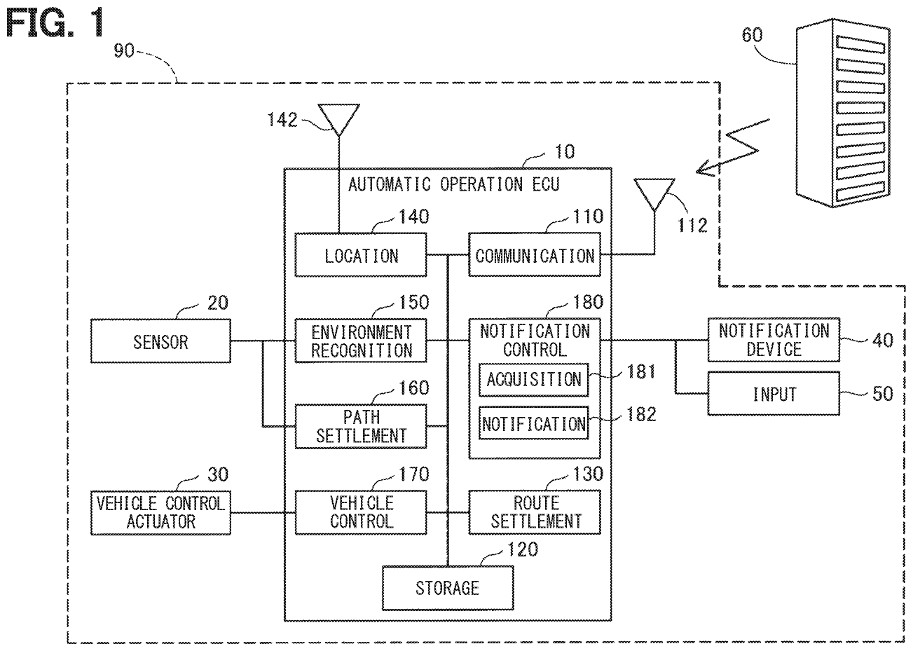

As illustrated in FIG. 1, an automatic operation ECU (Electronic Control Unit) 10 is comparable to a “control device” according to the present disclosure and is mounted on an automated driving vehicle 90. The automated driving vehicle 90 includes a sensor portion 20, a vehicle control actuator 30, a notification device 40, and an input portion 50, as well as the automatic operation ECU 10.

The sensor portion 20 detects a target or measures a distance to the target around the automated driving vehicle 90. The sensor portion 20 includes a LIDAR (Light Detection and Ranging), a millimeter-wave radar, and a camera, for example.

The vehicle control actuator 30 operates the automated driving vehicle 90. The vehicle control actuator 30 includes actuators to operate a steering unit, a brake system, a running gear, and a power unit mounted on the automated driving vehicle 90, for example.

The notification device 40 notifies various information by using images or sounds to an occupant (mainly, a driver) of the automated driving vehicle 90. The notification device 40 includes a display device and a speaker. The display device can use a HUD (Head-Up Display) or a display device provided for an instrument panel, for example. The “image” includes motion pictures and character strings.

The input portion 50 acquires the occupant's decision-making from the occupant. The input portion 50 includes a steering wheel, a lever, a button, a pedal, and a sound input device, for example. According to the present embodiment, the input portion 50 can cancel the automatic drive operation.

The automatic operation ECU 10 automatically operates the automated driving vehicle 90 by using the sensor portion 20, the vehicle control actuator 30, the notification device 40, and the input portion 50 described above. The automatic operation ECU 10 includes a CPU, RAM, and ROM. The CPU implements various automatic operation functions by loading a program stored in the ROM into the RAM and executing the program. The program may be recorded on a non-transitory tangible storage medium.

The automatic operation according to the present embodiment complies with level 1 or higher, or more favorably, level 2 or higher regulated by the National Highway Traffic and Safety Administration (NHTSA). At level 1, the automatic operation ECU 10 supports one of acceleration, steering, and braking. At level 2, the automatic operation ECU 10 observers an operation environment and simultaneously performs a plurality of operations for acceleration, steering, and braking.

The automatic operation ECU 10 includes a communication portion 110, a route settlement portion 130, a location portion 140, an environment recognition portion 150, a path settlement portion 160, a vehicle control portion 170, and a notification control portion 180. These portions are embodied by the software of various types of hardware such as ICs. The automatic operation ECU 10 further includes a storage portion 120.

The communication portion 110 acquires various types of information from an information center 60 via an antenna 112. The information the communication portion 110 acquires from the information center 60 includes traffic information, weather information, accident information, obstacle information, and traffic regulation information, for example. The communication portion 110 may use the inter-vehicle communication to acquire various types of information from other vehicles. The communication portion 110 may use the road-to-vehicle communication to acquire various types of information from roadside devices provided for specified places of a road.

The storage portion is comprised of flash memory and stores various types of information. The storage portion stores road information, for example. The road information includes the road type, the number of lanes, the regulation speed, the presence or absence of a crosswalk, and the presence or absence of the traffic light in terms of intersections and roads, for example. The road information may be successively acquired from the information center 60 via the communication portion 110.

The route settlement portion 130 settles or searches for a route to the destination specified by the occupant based on the road information stored in the storage portion 120.

The location portion 140 uses an antenna 142 to measure a current position of the automated driving vehicle 90 based on a navigation signal received from a satellite configuring the GNSS (Global Navigation Satellite System).

The environment recognition portion 150 uses the sensor portion 20 to recognize the surrounding environment or a target for the automated driving vehicle 90.

The path settlement portion 160 settles a path the automated driving vehicle 90 travels. The path signifies a line that is practically traveled on the route. The path settlement portion 160 successively settles paths during the automated travel and determines a drive operation to travel the path according to the reason resulting from the current position of the automated driving vehicle 90 located by the location portion 140, the route settled by the route settlement portion 130, the surrounding environment and the target recognized by the environment recognition portion 150, and the obstacle information acquired by the communication portion 110, for example. The drive operation includes steering to the right, steering to the left, accelerating, decelerating, moving backward, or stopping, for example. These drive operations result from reasons such as turning to the right, turning to the left, going straight down an intersection, changing the lane, merging to a lane, passing, completing an emergency stop, and avoiding an obstacle, for example.

The vehicle control portion 170 uses the vehicle control actuator 30 to automatically operate the automated driving vehicle 90 based on the drive operation determined by the path settlement portion 160.

The notification control portion 180 uses the notification device 40 to notify various types of information to the occupant. The notification control portion 180 includes an acquisition portion 181 and a notification portion 182.

The acquisition portion 181 acquires the type of drive operation performed on the automated driving vehicle during the automatic operation and the information representing the reason to perform the drive operation from the path settlement portion 160.

When the acquisition portion 181 acquires at least the type of drive operation that accompanies the horizontal movement, the notification portion 182 uses the notification device 40 to notify the information to perform the drive operation accompanying the horizontal movement and the information representing the reason to move horizontally before the drive operation is performed. Further, when the acquisition portion 181 acquires the type of drive operation that accompanies the speed change (front-back movement), the notification portion 182 according to the present embodiment uses the notification device 40 to notify the information to perform the drive operation accompanying the speed change and the information representing the reason to change the speed. According to the present embodiment, the notification portion 182 changes the contents of the notification based on acceleration to move the automated driving vehicle 90. The drive operation accompanying the horizontal movement is hereinafter simply described as “horizontal movement.” The drive operation accompanying the speed change is hereinafter simply described as “speed change.”

When the occupant uses the input portion 50 to perform a specified operation to cancel the drive operation notified by the notification portion 182, the notification control portion 180 requests the path settlement portion 160 to cancel the drive operation. The path settlement portion 160 receives the request to cancel the drive operation from the notification control portion 180 and then cancels the drive operation. The user can cancel the drive operation by operating a steering wheel, a brake pedal, or an accelerator pedal, pressing a cancellation button provided for the steering wheel, a dashboard, or a center console, or acoustically issuing an instruction to cancel the drive operation, for example.

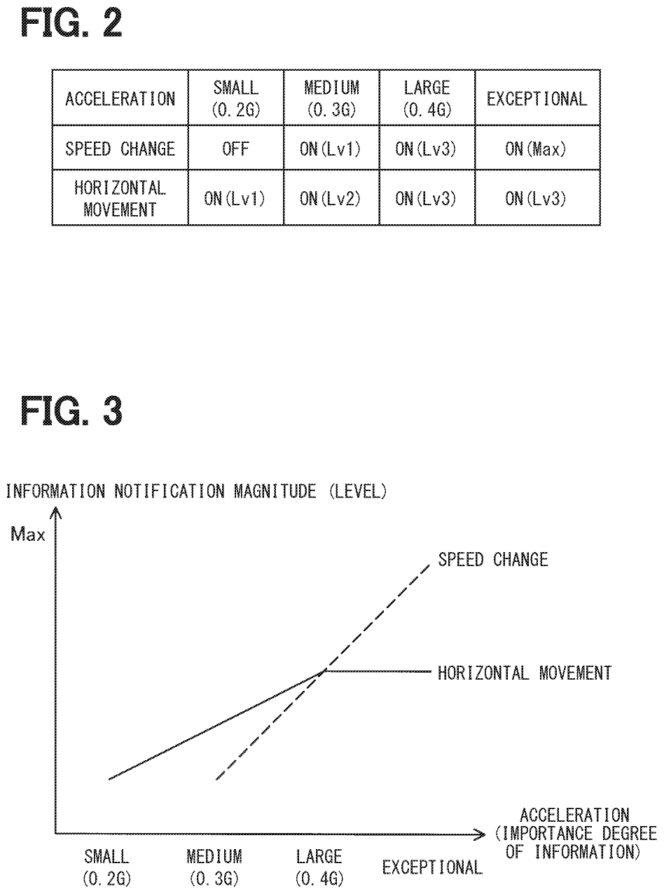

As illustrated in FIGS. 2 and 3, when the speed change and the horizontal movement are performed as the drive operations during the automatic operation, the notification portion 182 according to the present embodiment changes the information notification magnitude corresponding to the degree (acceleration). The information notification magnitude signifies the degree of information notified to an occupant. The acceleration values in FIG. 2 and later are all provided as examples and can be specified otherwise.

According to the present embodiment, as illustrated in FIG. 3, an increase in the acceleration during the drive operation increases the information notification magnitude (level) of the speed change and the horizontal movement. To a certain degree of acceleration, however, the information is reservedly notified in terms of the speed change compared to the horizontal movement. Therefore, according to the present embodiment, the normal driving increases the amount of information notified due to the horizontal movement compared to the speed change. According to the present embodiment, an increase in the acceleration increases the information notification level. According to the present embodiment, the acceleration to perform the speed change or the horizontal movement indicates the importance degree of the information notified in the drive operation. For example, there may be an exceptional case where the speed change (sudden deceleration) occurs to prevent the collision. In such a case, the information notification magnitude in the speed change is greater than the information notification magnitude in the horizontal movement.

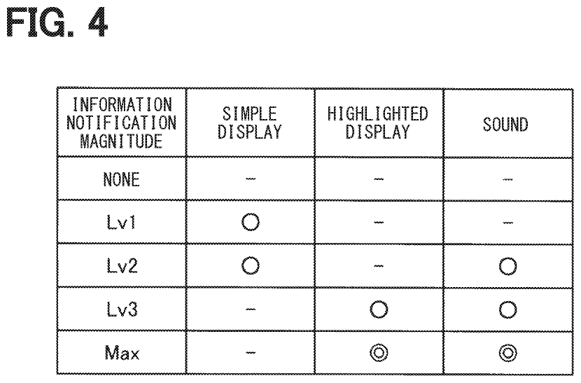

As illustrated in FIG. 4, the notification portion 182 notifies information by using image and sound. Specifically, when the information notification magnitude is level 1, the notification portion 182 allows the notification device 40 to simply display an image that notifies the type of the drive operation and the reason to perform the drive operation. When the information notification magnitude is level 2, the notification portion 182 notifies the information by using the image and the sound. When the information notification magnitude is level 3, the notification portion 182 notifies the information by using the image and the sound similarly to level 2 and blinks the image to more highlight the notification than level 2. When the information notification magnitude is maximum, the notification portion 182 increases the speed of blinking the image and increases the volume of the sound to most highlight the notification. The mode of highlighting the image and the sound is not limited to the adjustment of the blink speed and the sound volume. For example, the image may be highlighted by changing the color or the brightness of an image. For example, the sound may be highlighted by changing the tone or the type of sound. The sound may be provided as a buzzer or a chime or as a synthesized voice or a recorded voice to notify the reason for the horizontal movement or the speed change.

The notification portion 182 can use images to simultaneously notify the horizontal movement and the reason for the same without the use of character strings. For example, the notification portion 182 can simultaneously notify the horizontal movement and the reason for the same by displaying a mark representing the left turn or the right turn, a mark representing the lane change to the right or the left, a mark representing the passing from the right or the left, and a mark representing the U-turn to the right or the left. The notification portion 182 can use images to simultaneously notify the speed change and the reason for the same without the use of character strings. For example, the notification portion 182 can simultaneously notify the speed change and the reason for the same by displaying a mark representing the lane change to the passing lane, a mark representing the merge from an ordinary road to an express highway, and a mark representing the emergency stop.

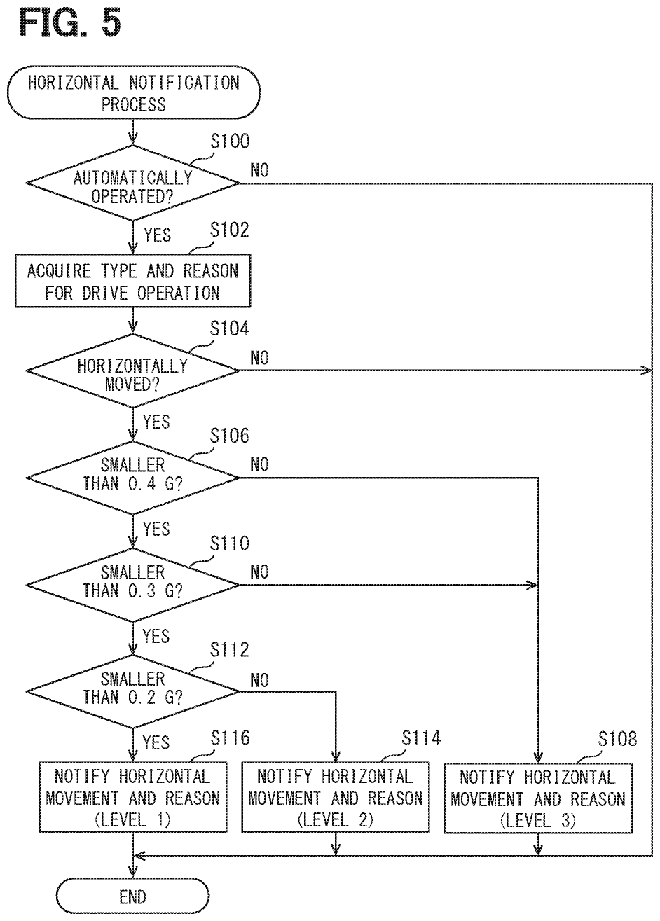

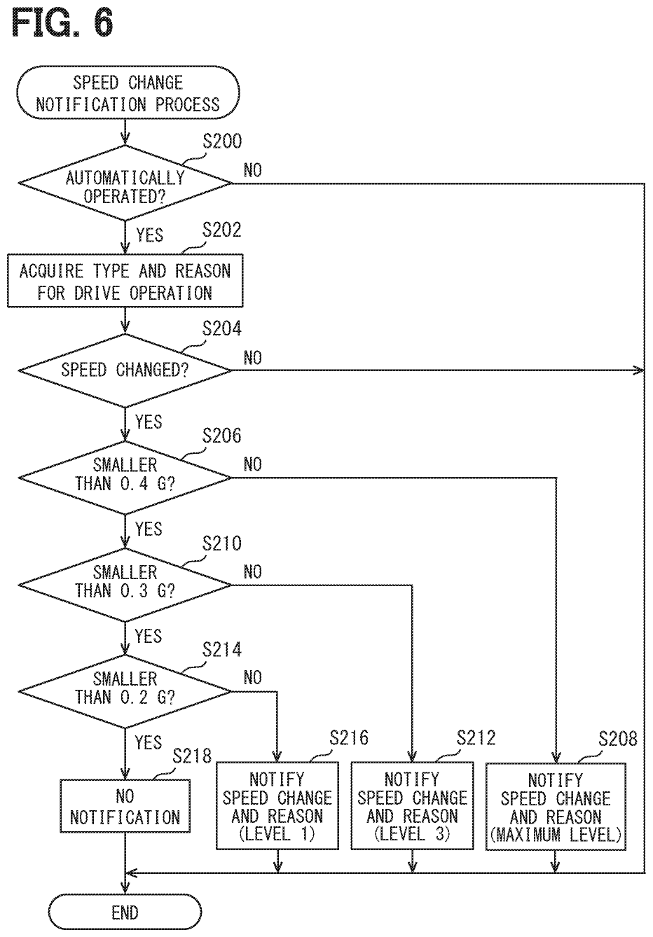

With reference to FIGS. 5 and 6, the description below explains the contents of notification processes performed by the notification control portion 180. The notification control portion 180 of the automatic operation ECU 10 parallel and repeatedly performs the horizontal notification process illustrated in FIG. 5 and the speed change notification process illustrated in FIG. 6.

During the horizontal notification process illustrated in FIG. 5, the notification control portion 180 determines whether the automated driving vehicle 90 is automatically operated (step S100). If the automated driving vehicle 90 is not automatically operated (step S100: No), namely, an occupant manually drives the vehicle, the notification control portion 180 skips all the steps to be described later and performed in the horizontal notification process. Meanwhile, if the automated driving vehicle 90 is automatically operated (step S100: Yes), the notification control portion 180 acquires the type of the drive operation to be performed next and the information indicating the reason to perform the drive operation from the path settlement portion 160 (step S102).

The notification control portion 180 determines whether the type of the drive operation acquired in step S102 is the horizontal movement (step S104). If the type of the drive operation is not the horizontal movement (step S104: No), the notification control portion 180 skips all the steps to be described later and performed in the horizontal notification process. The horizontal movement signifies steering the automated driving vehicle 90 to the right or the left. Reasons for the horizontal movement include turning to the left, turning to the right, changing the lane to the right, changing the lane to the left, making a U-turn, traveling a tight curve, passing a preceding vehicle, and taking action to allow an emergency vehicle to pass, for example.

If the type of the drive operation acquired from the path settlement portion 160 is equal to the horizontal movement (step S104: Yes), the notification control portion 180 determines whether an acceleration applied in the horizontal direction (horizontal G) due to the horizontal movement is smaller than 0.4 G (step S106). For example, the notification control portion 180 uses the steering angle and the vehicle speed during the horizontal movement in the drive operation determined by the path settlement portion 160 and estimates the acceleration based on a predetermined function or map. If horizontal G is greater than or equal to 0.4 G (step S106: No), the process proceeds to step S108 and allows the notification portion 182 to immediately notify the horizontal movement and the reason for the same according to level 3 (see FIG. 4).

If horizontal G is smaller than 0.4 G (step S106: Yes), the notification control portion 180 determines whether horizontal G is smaller than 0.3 G (step S110). If horizontal G is greater than or equal to 0.3 G (step S110: No), the process proceeds to step S108 and allows the notification portion 182 to immediately notify the horizontal movement and the reason for the same according to level 3 (see FIG. 4).

If horizontal G is smaller than 0.3 G (step S110: Yes), the notification control portion 180 determines whether horizontal G is smaller than 0.2 G (step S112). If horizontal G is greater than or equal to 0.2 G (step S112: No), the process proceeds to step S114 and allows the notification portion 182 to notify the horizontal movement and the reason for the same according to level 2 (see FIG. 4). If horizontal G is smaller than 0.2 G (step S112: Yes), the process proceeds to step S116 and allows the notification portion 182 to notify the horizontal movement and the reason for the same according to level 1 (see FIG. 4).

As above, the horizontal notification process according to the present embodiment is sure to notify the occupant of the horizontal movement and the reason for the same despite small horizontal G when horizontal movement occurs.

During the speed change notification process as illustrated in FIG. 6, the notification control portion 180 determines whether the automated driving vehicle 90 is automatically operated (step S200). If the automated driving vehicle 90 is not automatically operated (step S200: No), the notification control portion 180 skips all the steps to be described later and performed in the speed change notification process. If the automated driving vehicle 90 is automatically operated (step S200: Yes), the notification control portion 180 acquires the type of the drive operation to be performed next and the information indicating the reason to perform the drive operation from the path settlement portion 160 (step S202).

The notification control portion 180 determines whether the type of the drive operation acquired in step S202 is the speed change (step S204). If the type of the drive operation is not the speed change (step S204: No), the notification control portion 180 skips all the steps to be described later and performed in the speed change notification process. The speed change signifies that the automated driving vehicle 90 starts traveling forward or backward or changes the speed to travel straight or backward. Reasons to perform the speed change include starting, stopping, merging to a limited highway or an express highway, detecting an obstacle or making an emergency stop due to an accident, detecting a low-speed vehicle, relieving traffic congestion, and taking action to allow an emergency vehicle to pass, for example.

If the type of the drive operation acquired from the path settlement portion 160 is equal to the speed change (step S204: Yes), the notification control portion 180 determines whether an acceleration applied in the vertical direction (vertical G) due to the speed change is smaller than 0.4 G (step S206). The notification control portion 180 acquires an acceleration for the speed change from the path settlement portion 160, for example. If vertical G is greater than or equal to 0.4 (step S206: No), the process proceeds to step S208 and allows the notification portion 182 to immediately notify the speed change and the reason for the same by using the maximum level (see FIG. 4).

If vertical G is smaller than 0.4 G (step S206: Yes), the notification control portion 180 determines whether vertical G is smaller than 0.3 G (step S210). If vertical G is greater than or equal to 0.3 G (step S210: No), the process proceeds to step S212 and allows the notification portion 182 to immediately notify the speed change and the reason for the same according to level 3 (see FIG. 4).

If vertical G is smaller than 0.3 G (step S210: Yes), the notification control portion 180 determines whether vertical G is smaller than 0.2 G (step S214). If vertical G is greater than or equal to 0.2 G (step S214: No), the process proceeds to step S216 and allows the notification portion 182 to notify the speed change and the reason for the same according to level 1 (see FIG. 4). If vertical G is smaller 0.2 G (step S214: Yes), the notification portion 182 gives no notification (step S218).

As above, the speed change notification process according to the present embodiment gives no notification when vertical G is small. Therefore, the information about the speed change is reservedly notified compared to the horizontal movement.

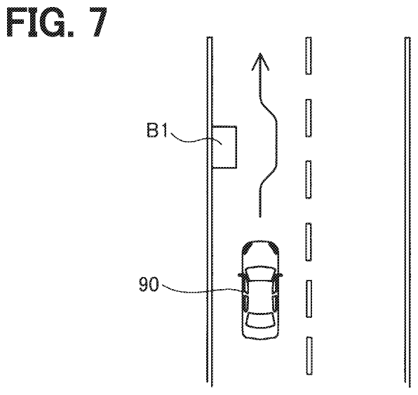

The description below explains exemplary situations in which the horizontal movement notification process and the speed change notification process described above notify the information. For example, FIG. 7 illustrates that the automated driving vehicle 90 travels the same lane and performs the horizontal movement within the same lane to avoid obstacle B1. If horizontal G is smaller than 0.2 G, the notification portion 182 notifies the horizontal movement and the reason for the same according to level 1. The notification portion 182 gives no notification about the speed change when the automated driving vehicle 90 travels the same lane and the acceleration is smaller than 0.2 G for the acceleration or deceleration.

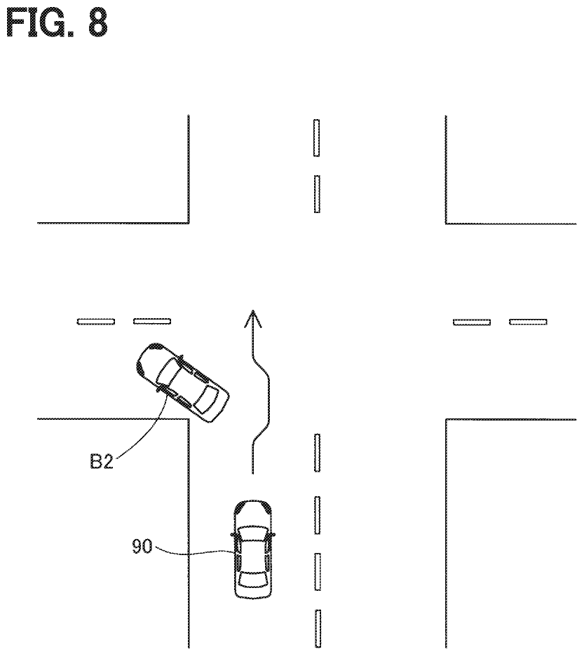

FIG. 8 illustrates that the automated driving vehicle 90 travels an intersection and performs the horizontal movement to avoid another vehicle B2 that waits to turn to the right or left. If horizontal G is smaller than 0.2 G, the notification portion 182 notifies the horizontal movement and the reason for the same according to level 1. When the automated driving vehicle 90 turns to the right or left at the intersection, if horizontal G is smaller than 0.2 G, the notification portion 182 notifies the horizontal movement and the reason for the same according to level 1. The notification portion 182 gives no notification when the automated driving vehicle 90 straight passes through the intersection.

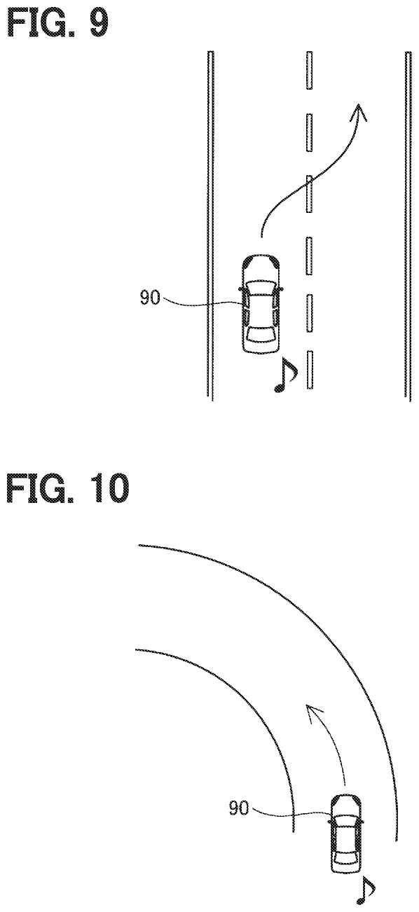

FIG. 9 illustrates that the automated driving vehicle 90 changes the lane. If horizontal G ranges from 0.2 to 0.3 G to change the lane, for example, the notification portion 182 notifies the horizontal movement and the reason (lane change) for the same according to level 2. The notification portion 182 gives no notification about the speed change if the acceleration is smaller than 0.2 G for the acceleration or deceleration.

FIG. 10 illustrates that the automated driving vehicle 90 travels a large curvature corner (tight curve). If the curve travel causes horizontal G ranging from 0.2 to 0.3 G, the notification portion 182 notifies the horizontal movement and the reason for the same (tight curve travel) according to level 2. The notification portion 182 gives no notification about the speed change if the acceleration is smaller than 0.2 G for the acceleration or deceleration.

FIG. 11 illustrates that the vehicle merges to the main lane from a merging lane. If the acceleration causes horizontal G ranging from 0.3 to 0.4 G, the notification portion 182 notifies the implementation of the speed change and the reason for the same (merge) according to level 3. The notification portion 182 also notifies the implementation of the horizontal movement and the reason for the same.

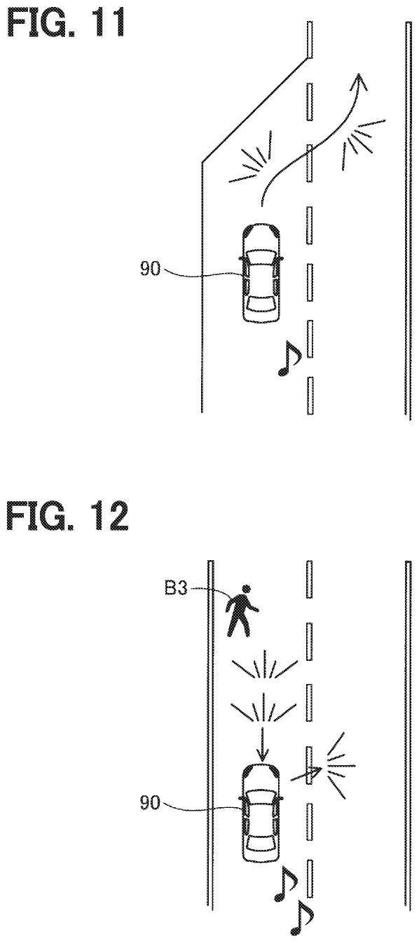

FIG. 12 illustrates that the vehicle urgently avoids suddenly appearing obstacle B3. If vertical G due to the deceleration is 0.4 G or more, the notification portion 182 notifies the implementation of the speed change and the reason for the same (emergency avoidance) according to the maximum level. When the emergency avoidance causes the horizontal movement, the notification portion 182 also notifies the implementation of the horizontal movement.

According to the above-described first embodiment, the automated driving vehicle 90 may automatically perform the type of drive operation accompanying the horizontal movement. In this case, the notification portion 182 uses the notification device 40 to notify the information representing the implementation of the drive operation accompanying the horizontal movement and the information representing the reason for the implementation of the horizontal movement before the drive operation is performed. The occupant can easily foresee the drive operation of the automated driving vehicle. As a result, the occupant can easily determine whether to cancel the automatically performed drive operation.

When the type of the automatically performed drive operation causes the speed change, the present embodiment notifies the implementation of the drive operation accompanying the speed change and the reason for the implementation of the speed change. The occupant can more easily foresee the drive operation of the automated driving vehicle.

The present embodiment changes notification modes such as the simple display, the highlighted display, and the combination with sound depending on accelerations for the horizontal movement and the speed change in drive operations. The occupant can intuitively understand the importance of the automatically performed drive operation.

### B. Second Embodiment

The first embodiment has described the horizontal notification process and the speed change notification process as the notification processes performed on the automated driving vehicle 90. The second embodiment performs a notification process different from these notification processes. The automated driving vehicle 90 according to the second embodiment is configured equally to the first embodiment. The description below explains the same configurations as those of the first embodiment by using the same reference symbols as the first embodiment.

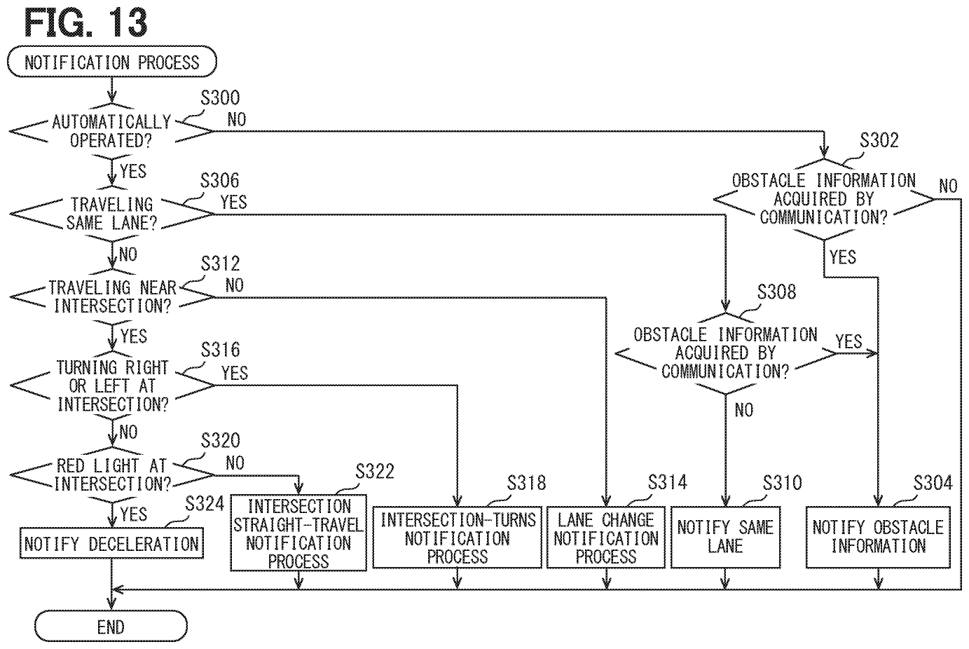

FIG. 13 illustrates the notification process according to the second embodiment. The automatic operation ECU 10 determines whether the automated driving vehicle 90 is automatically operated (step S300). If the automated driving vehicle 90 is not automatically operated (step S300: No), the automatic operation ECU 10 allows the communication portion 110 to determine whether obstacle information is acquired (step S302). If the obstacle information is acquired (step S302: Yes), the notification portion 182 notifies the obstacle information by using an image, a character string, or sound (step S304). If no obstacle information is acquired (step S302: No), the notification portion 182 gives no notification.

If the automated driving vehicle 90 is automatically operated (step S300: Yes), the automatic operation ECU 10 determines whether the automated driving vehicle 90 travels the same lane, based on the path settled by the path settlement portion 160 (step S306). If the same lane is traveled (step S306: Yes), the automatic operation ECU 10 allows the communication portion 110 to determine whether obstacle information is acquired (step S308). If the obstacle information is acquired (step S308: Yes), the notification portion 182 notifies the obstacle information by using an image, a character string, or sound (step S30). If no obstacle information is acquired (step S308: No), the notification portion 182 notifies that the same lane is traveled (step S310).

If the same lane is not traveled (step S306: No), the automatic operation ECU 10 determines whether the travel occurs near an intersection, based on the current position and the route (step S312). If the travel does not occur near an intersection (step S312: No), the automated driving vehicle 90 does not travel the same lane or an intersection. Then, the automated driving vehicle 90 changes the lane. The automatic operation ECU 10 performs a lane change notification process (step S314). The lane change notification process will be described in detail later.

If the travel occurs near an intersection (step S312: Yes), the automatic operation ECU 10 determines whether the right or left turn occurs at an intersection, based on the path (step S316). If the right or left turn occurs (step S316: Yes), the automatic operation ECU 10 performs an intersection-turns notification process (step S318). The intersection-turns notification process will be described in detail later.

If the right or left turn occurs at an intersection (step S316: No), the automatic operation ECU 10 uses the environment recognition portion 150 to determine whether the light turns red at the intersection, based on the information acquired by the camera of the sensor portion 20 (step S320). If the light does not turn red (step S320: No), the automatic operation ECU 10 performs an intersection straight-travel notification process (step S322). The intersection straight-travel notification process will be described in detail later. If the light turns red (step S320: Yes), the notification portion 182 notifies the deceleration (step S324). The automatic operation ECU 10 repeatedly performs the above-described process.

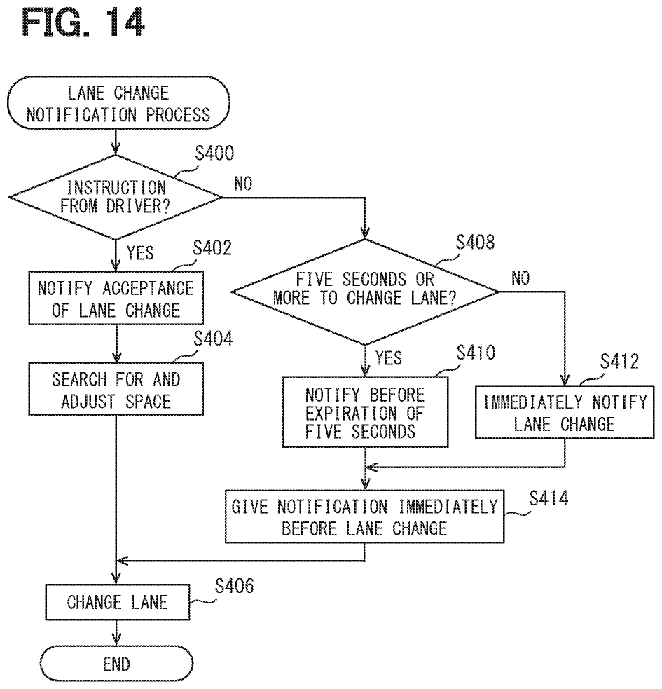

With reference to FIG. 14, the description below explains the lane change notification process performed in step S314 of FIG. 13. When the lane change notification process is performed, the automatic operation ECU 10 determines whether the occupant instructs the lane change (step S400). During the automatic operation, the occupant can forcibly instruct the lane change by manipulating a direction indicator switch, for example. If the occupant instructs the lane change (step S400: Yes), the notification portion 182 notifies that the lane change instruction is accepted (step S402). The automatic operation ECU 10 searches for and adjusts a position and a space to shift to the adjacent lane according to the environment that surrounds the automated driving vehicle 90 and is recognized by the environment recognition portion 150 (step S404). At this time, the notification portion 182 may notify that action is taken to search for and adjust a position and a space to shift to the adjacent lane. The automatic operation ECU 10 changes the lane to the searched position (step S406).

If the occupant does not instruct the lane change (step S400: No), the automatic operation determines the lane change as the drive operation. In this case, the automatic operation ECU 10 determines whether it takes five seconds or more to practically perform the lane change (step S408). If it takes five seconds or more to practically perform the lane change (step S408: Yes), the notification portion 182 notifies before the expiration of five seconds that the lane change will occur soon (step S410). If it takes fewer than five seconds to practically perform the lane change (step S408: No), the notification portion 182 immediately notifies at the time that the lane change occurs (step S412). Immediately before the lane change occurs, the notification portion 182 notifies that the lane change occurs (step S414). Namely, the notification portion 182 gives a plurality of notifications (steps S410, S412, and S414) until the reach to the place where the lane change is performed. After that, the automatic operation ECU 10 performs the lane change according to the path settled by the path settlement portion 160 (step S406). The duration of “five seconds” is an example and may be set to other values. The same applies to other durations described below.

The contents and the mode notified in steps S410, S412, and S414 are equal to the contents and the mode of the notification in the horizontal notification process described in the first embodiment. Namely, the notification mode varies with vertical G at the lane change. The contents notified in step S414 may differ from those in step S410 or S412. For example, the notification portion 182 may notify the simplified contents of the lane change in step S410 that leaves time until the lane change is practically performed. The notification portion 182 may notify the detailed contents in step S414 immediately before the lane change. The notification portion 182 may notify the detailed contents of the lane change in step S410 that leaves time until the lane change is practically performed. The notification portion 182 may notify the simplified contents in step S414 immediately before the lane change. The detailed information about the lane change represents the direction and the reason for the implementation of the lane change, for example. The simplified information about the lane change simply represents that the lane change is performed, for example.

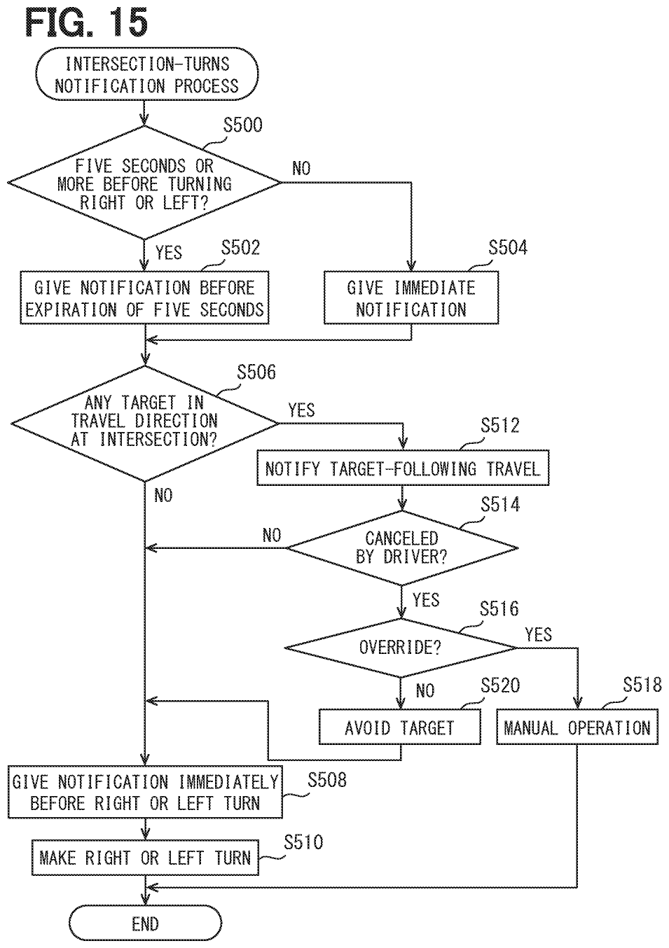

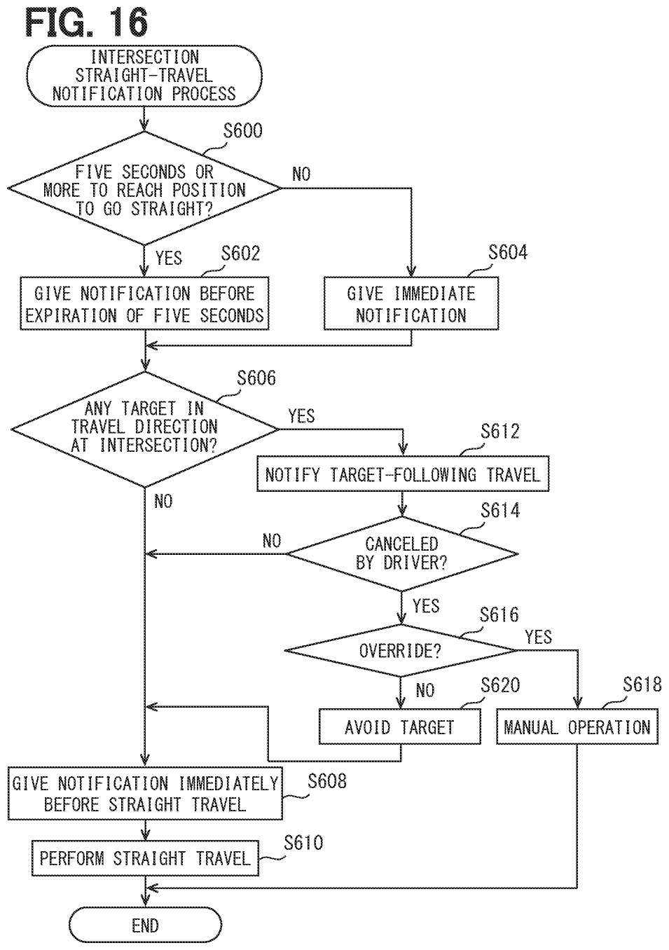

With reference to FIG. 15, the description below explains the intersection-turns notification process in step S318 of FIG. 13. When the intersection-turns notification process is performed, the automatic operation ECU 10 determines whether it takes five seconds or more to reach the position to turn right or left at an intersection (step S500). If it takes five seconds or more until the right or left turn (step S500: Yes), the notification portion 182 notifies before the expiration of five seconds that the right or left turn will occur soon (step S502). If it takes fewer than five seconds until the right or left turn (step S500: No), the notification portion 182 immediately notifies at the time that the right or left turn occurs (step S504).

The automatic operation ECU 10 determines whether a target exists in the travel direction (corresponding to the right or left turn) at the intersection according to the environment that surrounds the automated driving vehicle 90 and is recognized by the environment recognition portion 150 (step S506). The target in the intersection-turns information presentation process signifies low-speed vehicles such as bicycles, motorized bicycles, and small-sized farm vehicles, for example. If no target exists (step S506: No), the notification portion 182 notifies that the right or left turn is performed, immediately before the right or left turn (step S508). The notification portion 182 gives a plurality of notifications at the different timings (steps S502, S504, and S508) until reaching the place to make the right or left turn. Then, the automatic operation ECU 10 performs the right or left turn according to the path settled by the path settlement portion 160 (step S510).

If a target exists in the travel direction at the intersection (step S506: Yes), the notification portion 182 proceeds to step S512 and notifies that the vehicle travels by following the target (target-following travel). The automatic operation ECU 10 determines whether the occupant uses the input portion 50 to cancel the target-following travel (step S514). If the target-following travel is not canceled (step S514: No), the notification portion 182 notifies that the right or left turn is performed, immediately before the right or left turn (step S508). Then, the automatic operation ECU 10 performs the right or left turn according to the path settled by the path settlement portion 160 while following the target (step S510).

If the occupant cancels the target-following travel (step S514: Yes), it is determined whether the occupant overrides the drive operation (step S516). The override in the intersection-turns information notification process signifies the occupant's manipulation on a steering wheel. If the occupant overrides the drive operation, the manual operation is used for driving (step S518). If the occupant does not override the drive operation (step S516: No), the path settlement portion 160 settles a path for the right or left turn to avoid the target (step S520). The notification portion 182 notifies immediately before the right or left turn that the right or left turn is made (step S508). The automatic operation ECU 10 performs the right or left turn according to the path settled by the path settlement portion 160 while avoiding the target (step S510).

With reference to 16, the description below explains the intersection straight-travel notification process in step S322 of FIG. 13. When the intersection straight-travel notification process is performed, the automatic operation ECU 10 determines whether it takes five seconds or more to reach the position to go straight at an intersection (step S600). If it takes five seconds or more to reach the position to go straight at the intersection (step S600: Yes), the notification portion 182 notifies before the expiration of five seconds that the straight travel occurs soon (step S602). If it takes fewer than five seconds to reach the position to go straight at the intersection (step S600: No), the notification portion 182 immediately notifies at the time that the straight travel occurs (step S604).

The automatic operation ECU 10 determines whether a target exists in the straight direction at the intersection according to the environment that surrounds the automated driving vehicle 90 and is recognized by the environment recognition portion 150 (step S606). The target in the intersection straight-travel notification process signifies not only low-speed vehicles such as bicycles, motorized bicycles, and small-sized farm vehicles but also ordinary vehicles such as standard-sized cars, for example. When a target exists in the straight direction at the intersection in the intersection straight-travel notification process, it is assumed that there is a vehicle waiting to turn to the right or left in the straight direction. If no target exists (step S606: No), the notification portion 182 notifies immediately before the straight travel at the intersection that the straight travel is performed at the intersection (step S608). The notification portion 182 gives a plurality of notifications at the different timings (steps S602, S604, and S608) until the straight travel is performed at the intersection. The automatic operation ECU 10 then performs the straight travel according to the path settled by the path settlement portion 160 (step S610).

If a target exists in the straight direction at the intersection (step S606: Yes), the notification portion 182 proceeds to step S612 and notifies that the vehicle travels by following the target (target-following travel). The automatic operation ECU 10 determines whether the occupant uses the input portion 50 to cancel the target-following travel (step S614). If the target-following travel is not canceled (step S614: No), the notification portion 182 notifies that that the straight travel is performed, immediately before straight traveling the intersection (step S608). The automatic operation ECU 10 then performs the straight travel according to the path settled by the path settlement portion 160 while following the target (step S610).

If the occupant cancels the target-following travel (step S614: Yes), it is determined whether the occupant overrides the drive operation (step S616). The override in the intersection straight-travel information notification process signifies the occupant's manipulation on a steering wheel. If the occupant overrides the drive operation, the manual operation is used for driving (step S618). If the occupant does not override the drive operation (step S616: No), the path settlement portion 160 settles a path for the straight travel to avoid the target (step S620). The notification portion 182 notifies immediately before straight traveling the intersection that the straight travel is performed at the intersection (step S608). The automatic operation ECU 10 performs the straight travel according to the path settled by the path settlement portion 160 while avoiding the target (step S610).

The above-described second embodiment can notify the occupant of optimal information depending on travel situations of the automated driving vehicle 90, namely, depending on whether the automatic operation is active, the vehicle is traveling the same lane, the vehicle is traveling near an intersection, or a red light exists at the intersection. When an intersection is traveled, the occupant is notified of an occurrence of the right or left turn or the straight travel based on at least two timings, namely, five seconds before reach to the intersection and immediately before reach to the intersection. The occupant can be given sufficient time to determine whether to cancel the automatically performed drive operation. Further, the present embodiment notifies the obstacle information acquired by the communication even when the automatic operation is not performed. The occupant can safely travel based on the information.

### C. Other Embodiments

### C1. Another Embodiment

In the above-described embodiments, the occupant may issue an instruction by using the input portion 50 to enable or disable the notification portion 182 from notifying the information. When the information notification is disabled, the notification portion 182 does not perform notification in the above-described processes.

### C2. Still Another Embodiment

The lane change notification process, the intersection-turns notification process, and the intersection straight-travel notification process in the above-described embodiments perform the notification when the remaining time before the implementation of the drive operation reaches a predetermined time (five seconds). Meanwhile, the drive operation may be notified when a distance from a point to perform the drive operation reaches a predetermined distance. For example, the notification may be performed 100 m or 300 m behind the point to perform the drive operation.

### C3. Yet Another Embodiment

In the above-described embodiments, the automatic operation ECU 10 may not perform the speed change notification process illustrated in FIG. 6. The automatic operation ECU 10 may not perform the notification process illustrated in FIG. 13. The notification control portion 180 may not change the notification mode depending on accelerations.

The present disclosure can be embodied in various forms other than the control device. For example, the present disclosure can be embodied in such forms as a method performed by the control device mounted on the automated driving vehicle, a computer program to execute the method, and a non-transitory tangible storage medium to store the computer program.

The control portion and the technique of the same described in the present disclosure may be embodied by a dedicated computer that is provided by configuring a processor and memory programmed to execute one or more functions embodied by a computer program. Alternatively, the control portion and the technique of the same described in the present disclosure may be embodied by a dedicated computer that is provided by configuring a processor using one or more dedicated hardware logic circuits. Alternatively, the control portion and the technique of the same described in the present disclosure may be embodied by one or more dedicated computers configured as a combination of a processor and memory programmed to execute one or more functions and a processor comprised of one or more hardware logic circuits. A computer-readable non-transitory tangible storage medium may store the computer program as an instruction executed by a computer.

The present disclosure is not limited to the above-described embodiments but can be embodied in various configurations without departing from the spirit and scope thereof. For example, the technical features in the embodiments corresponding to the technical features according to the aspects described in the summary can be interchanged or combined as appropriate to solve all or part of the above-described issues or to achieve all or part of the above-described effects. A technical feature, if not stated as an essential part in the present specification, can be eliminated as appropriate

Here, the process of the flowchart or the flowchart described in this application includes a plurality of sections (or steps), and each section is expressed as, for example, S1. Further, each section may be divided into several subsections, while several sections may be combined into one section. Furthermore, each section thus configured may be referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A control device mounted on an autonomous driving vehicle, comprising:
an acquisition portion that acquires information representing a type of a drive operation and a reason for the drive operation being to be performed during an autonomous driving operation of the autonomous driving vehicle;
a notification portion that controls a notification device to notify information representing the drive operation for moving in a horizontal direction being to be performed and information representing the reason to move in the horizontal direction before the drive operation is performed when an acquired type of the drive operation corresponds to at least the drive operation for moving in the horizontal direction; and
an input portion that accepts a cancellation of an acquired drive operation, wherein:
the notification portion notifies a plurality of times at different timings until reaching a place to perform the drive operation.

2. The control device according to claim 1, further comprising:
one or more processors; and
a memory coupled to the one or more processors and storing program instructions that when executed by the one or more processors cause the one or more processors to provide at least an acquisition portion, a notification portion and an input portion.

3. The control device according to claim 1, wherein:
when the acquired type of the drive operation corresponds to the drive operation for changing a vehicle speed, the notification portion notifies the information of the drive operation for changing the vehicle speed and the reason to change the vehicle speed.

4. The control device according to claim 1, wherein:
the notification portion changes a notification mode depending on acceleration in the drive operation.

5. A method implemented by a control device mounted on an autonomous driving vehicle, the method comprising:
acquiring information representing a type of a drive operation and a reason for the drive operation being to be performed during an autonomous driving operation of the autonomous driving vehicle;
notifying information representing the drive operation for moving in a horizontal direction being to be performed and information representing the reason to move in the horizontal direction a plurality of times at different timings until reaching a place to perform the drive operation before the drive operation is performed when an acquired type of the drive operation corresponds to at least the drive operation for moving in the horizontal direction; and
accepting a cancellation of an acquired drive operation.

6. A control device mounted on an autonomous driving vehicle, comprising:
an acquisition portion that acquires information representing a type of a drive operation and a reason for the drive operation being to be performed during an autonomous driving operation of the autonomous driving vehicle; and
a notification portion that controls a notification device to notify information representing the drive operation for moving in a horizontal direction being to be performed and information representing the reason to move in the horizontal direction before the drive operation is performed when an acquired type of the drive operation corresponds to at least the drive operation for moving in the horizontal direction, wherein:
the notification portion notifies a plurality of times at different timings until reaching a place to perform the drive operation; and
when the notification portion notifies at different timings, the notification portion changes a detail in a content of notification according to time to reach a place to perform the drive operation.

7. The control device according to claim 6, further comprising:
one or more processors; and
a memory coupled to the one or more processors and storing program instructions that when executed by the one or more processors cause the one or more processors to provide at least an acquisition portion and a notification portion.

8. A method implemented by a control device mounted on an autonomous driving vehicle, the method comprising:
acquiring information representing a type of a drive operation and a reason for the drive operation being to be performed during an autonomous driving operation of the autonomous driving vehicle; and
notifying information representing the drive operation for moving in a horizontal direction being to be performed and information representing the reason to move in the horizontal direction a plurality of times at different timings until reaching a place to perform the drive operation before the drive operation is performed when an acquired type of the drive operation corresponds to at least the drive operation for moving in the horizontal direction, wherein:
when notifying at different timings, a detail in a content of notification is changed according to time to reach a place to perform the drive operation.
